(19) United States
(12) Patent Application Publication
(10) Pub. No.: US 2024/0265257 A1
(43) Pub. Date: Aug. 8, 2024

(54) MACHINE LEARNING DEVICE, MACHINE LEARNING METHOD, AND NON-TRANSITORY COMPUTER-READABLE RECORDING MEDIUM EMBODIED THEREON MACHINE LEARNING PROGRAM

(71) Applicant: JVCKENWOOD Corporation, Yokohama-shi (JP)

(72) Inventors: Shingo KIDA, Yokohama-shi (JP); Hideki TAKEHARA, Yokohama-shi (JP); Yincheng YANG, Yokohama-shi (JP); Maki TAKAMI, Yokohama-shi (JP)

(21) Appl. No.: 18/617,709

(22) Filed: Mar. 27, 2024

Related U.S. Application Data
(63) Continuation of application No. PCT/JP2022/021173, filed on May 24, 2022.

(30) Foreign Application Priority Data
Sep. 28, 2021 (JP) 2021-157331
Sep. 28, 2021 (JP) 2021-157332

(51) Int. Cl. G06N 3/08

(52) U.S. Cl. CPC G06N 3/08

(57) ABSTRACT

A machine learning device is provided that performs continual learning of a fewer number of novel classes than the number of base classes. A base class feature extraction unit extracts feature vectors of the base classes. A novel class feature extraction unit extracts feature vectors of the novel classes. A mixture feature calculation unit mixes the feature vectors of the base classes and the feature vectors of the novel classes and calculates a mixture feature vector of the base classes and the novel classes. A learning unit classifies a query sample of a query set based on the distance between the position of a mixture feature vector of the query sample of the query set and the position of a classification weight vector of each class in a projection space and learns classification weight vectors of the novel classes so as to minimize classification loss.

### CROSS REFERENCE TO RELATED APPLICATION

This application is a continuation of application No. PCT/JP2022/021173, filed on May 24, 2022, and claims the benefit of priority from the prior Japanese Patent Application No. 2021-157331, filed on Sep. 28, 2021, and the prior Japanese Patent Application No. 2021-157332, filed on Sep. 28, 2021, the entire content of which is incorporated herein by reference.

### BACKGROUND

### 1. Technical Field

The present disclosure relates to a machine learning technology.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-train CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in successive learning.

Incremental learning or continual learning is proposed as a scheme to avoid catastrophic forgetting. Continual learning is a learning method that improves a current trained model to learn new tasks and new data as they occur, instead of training the model from scratch.

On the other hand, since new tasks often have only a few pieces of sample data available, few-shot learning has been proposed as a method for efficient learning with a small amount of training data. In few-shot learning, new tasks are learned using another small amount of parameters without relearning parameters that have been learned once.

A method called incremental few-shot learning (IFSL) has been proposed in which continual learning, where novel classes are learned without catastrophic forgetting regarding learning results of base classes, and few-shot learning, where a fewer number of novel classes than the number of base classes are learned, are combined (Non-Patent Literature 1). In incremental few-shot learning, base classes can be learned from a large dataset and novel classes can be learned from a small number of sample data pieces.

[Non-Patent Literature 1] Yoon, S. W., Kim, D. Y., Seo, J., & Moon, J. (2020, November). XtarNet: Learning to extract task-adaptive representation for incremental few-shot learning. In International Conference on Machine Learning (pp. 10852-10860). PMLR.

As an incremental few-shot learning method, there is XtarNet described in Non-Patent Literature 1. In XtarNet, extraction of task-adaptive representations (TAR) is leaned in incremental few-shot learning; however, meta-learning for extraction has the problem that loss convergence is difficult, taking too much time for learning.

### SUMMARY

A machine learning device according to one embodiment is a machine learning device that performs continual learning of a fewer number of novel classes than the number of base classes, including: a base class feature extraction unit that extracts feature vectors of the base classes; a novel class feature extraction unit that extracts feature vectors of the novel classes; a mixture feature calculation unit that mixes the feature vectors of the base classes and the feature vectors of the novel classes and calculates a mixture feature vector of the base classes and the novel classes; and a learning unit that classifies a query sample of a query set based on the distance between the position of a mixture feature vector of the query sample of the query set and the position of a classification weight vector of each class in a projection space and learns classification weight vectors of the novel classes so as to minimize classification loss.

Another embodiment relates to a machine learning method. This method is a machine learning method that performs continual learning of a fewer number of novel classes than the number of base classes, including: extracting feature vectors of the base classes; extracting feature vectors of the novel classes; mixing the feature vectors of the base classes and the feature vectors of the novel classes and calculating a mixture feature vector of the base classes and the novel classes; and classifying a query sample of a query set based on the distance between the position of a mixture feature vector of the query sample of the query set and the position of a classification weight vector of each class in a projection space and learning classification weight vectors of the novel classes so as to minimize classification loss.

Optional combinations of the aforementioned constituting elements and implementations of the present embodiments in the form of methods, apparatuses, systems, recording mediums, and computer programs may also be practiced as additional modes of the present embodiments.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1A is a diagram explaining the configuration of a pre-training module;

FIG. 1B is a diagram explaining the configuration of an incremental few-shot learning module;

FIG. 1C is a diagram explaining episodic training;

FIG. 2A is a diagram explaining a configuration for generating task-specific mixture weight vectors for calculating a task-adaptive representation from a support set;

FIG. 2B is a diagram explaining a configuration for calculating a task-adaptive representation from a support set so as to generate a classification weight vector set W based on the task-adaptive representation;

FIG. 3 is a diagram explaining a configuration for calculating a task-adaptive representation from a query set and classifying a query sample based on the task-adaptive representation and a task-adjusted classification weight vector set so as to minimize classification loss;

FIG. 4 is a conceptual diagram of a projection space;

FIGS. 5A to 5C are diagrams explaining a conventional episodic learning procedure;

FIG. 6 is a configuration diagram of a machine learning device according to the first embodiment of the present disclosure;

FIGS. 7A to 7C are diagrams explaining an episodic learning procedure according to the first embodiment;

FIG. 8A to 8C are diagrams explaining a conventional loss calculation procedure for query samples;

FIG. 9 is a flowchart showing a conventional loss calculation procedure for a query sample;

FIG. 10 is a configuration diagram of a machine learning device according to the second embodiment of the present disclosure;

FIG. 11A to 11C are diagrams explaining a loss calculation procedure for conventional query samples according to the second embodiment; and

FIG. 12 is a flowchart showing a loss calculation procedure for a query sample according to the second embodiment.

### DETAILED DESCRIPTION

The invention will now be described by reference to the preferred embodiments. This does not intend to limit the scope of the present invention, but to exemplify the invention.

First, we will give an overview of incremental few-shot learning with XtarNet. XtarNet learns to extract task-adaptive representation (TAR). First, a backbone network that has been pretrained on a base class dataset is used so as to obtain features of the base class. An additional module that has been meta-trained across the episodes of a novel class is then used so as to obtain the features of the novel class. The mixture of the features of the base class and the features of the novel class is called a task-adaptive representation (TAR). Classifiers for the base and novel classes use this TAR to quickly adapt to a given task and perform a classification task.

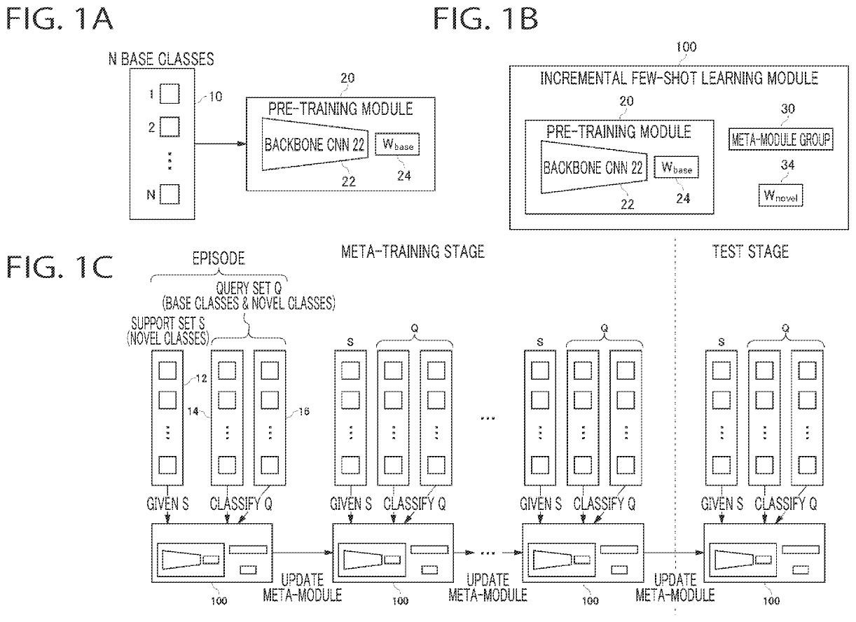

The outline of an XtarNet learning procedure will be explained with reference to FIGS. 1A to 1C.

FIG. 1A is a diagram explaining the configuration of a pre-training module 20. The pre-training module 20 includes a backbone CNN 22 and a base classification weight 24.

A dataset 10 of a base class includes N samples. An example of the samples is an image but is not limited thereto. A backbone CNN 22 is a convolutional neural network that pre-learns the dataset 10 of the base class. The base classification weight 24 represents a weight vector W_{base} of the base class classifier and indicates the average feature amount of the samples of the dataset 10 of the base class.

In a learning stage 1, the backbone CNN 22 is pretrained on the dataset 10 of the base class.

FIG. 1B is a diagram explaining the configuration of an incremental few-shot learning module 100. The incremental few-shot learning module 100 is a meta-module group 30 and a novel classification weight 34 added to the pre-training module 20 shown in FIG. 1A. The meta-module group 30 includes three multilayer neural networks described later and performs post-learning on the dataset of a novel class. The number of samples included in the dataset of the novel class is smaller compared to the number of samples included in the dataset of the base class. The novel classification weight 34 represents a weight vector Wₙₒᵥₑₗ of the novel class classifier and indicates the average feature amount of the samples of the dataset of the novel class.

In a learning stage 2, the meta-module group 30 is episodically trained based on the pre-training module 20.

FIG. 1C is a diagram explaining episodic training. The episodic training includes a meta-training stage and a test stage. The meta-training stage is executed for each episode, and the meta-module group 30 and the novel classification weight 34 are updated. The test stage performs a classification test using the meta-module group 30 and novel classification weight 34 updated in the meta-training stage.

Each episode consists of a support set S and a query set Q. The support set S consists of a dataset 12 of the novel class, and the query set Q consists of a dataset 14 of the base class and a dataset 16 of the novel class. In the learning stage 2, in each episode, query samples of both the base class and the novel class included in the query set Q are classified based on a support sample of the given support set S, and the parameters of the meta-module group 30 and the novel classification weight 34 are updated to minimize classification loss.

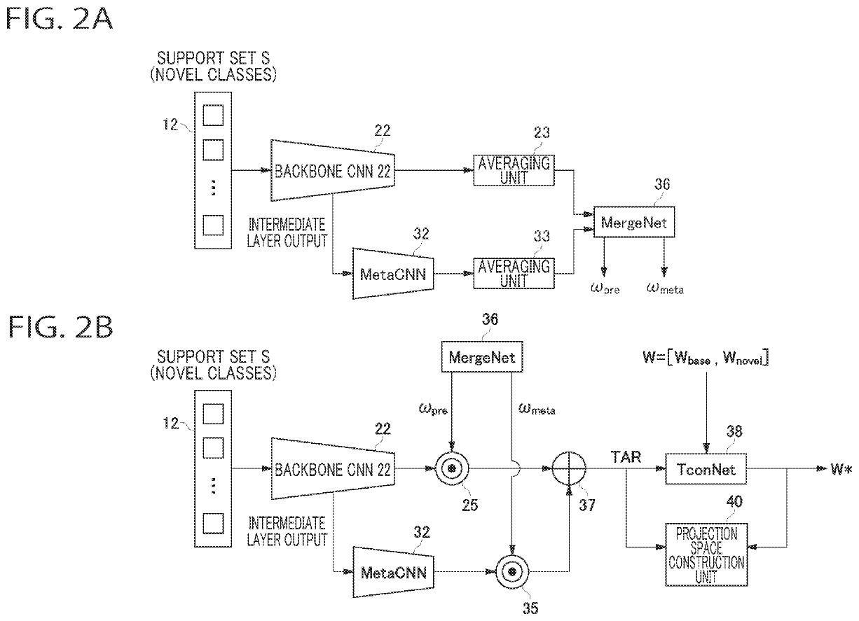

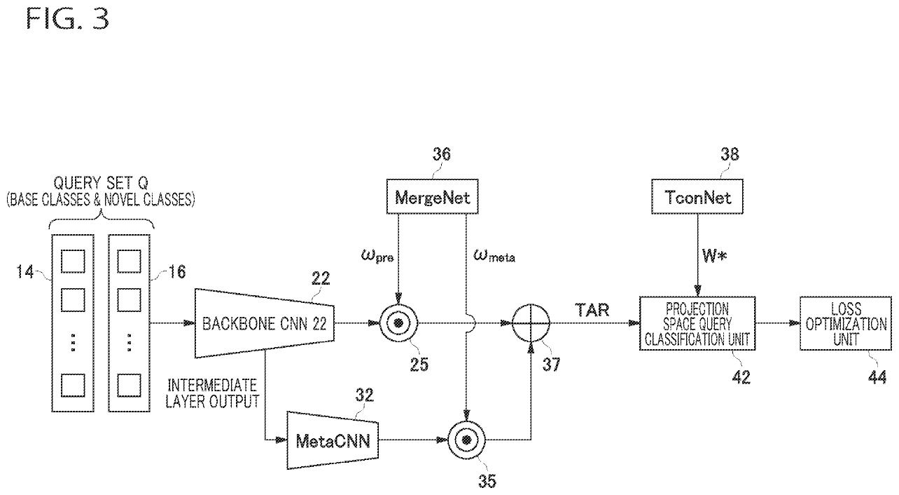

With reference to FIGS. 2A and 2B, the configuration related to the processing of the support set S in XtarNet will be explained, and with reference to FIG. 3, the configuration and learning process related to the processing of query set Q in XtarNet will be explained.

In addition to the backbone CNN 22, XtarNet utilizes the following three different meta-learnable modules as the meta-module group 30.
(1) MetaCNN: a neural network for extracting the features of a novel class
(2) MergeNet: a neural network for mixing the features of the base class with the features of the novel class
(3) TconNet: a neural network for adjusting the weight of a classifier

FIG. 2A is a diagram explaining a configuration for generating task-specific mixture weight vectors ωₚᵣₑ and ωₘₑₜₐ for calculating task-adaptive representation from the support set S.

The support set S includes the dataset 12 of the novel class. Each support sample of the support set S is input into the backbone CNN 22. The backbone CNN 22 processes the support sample, outputs a feature vector of the base class, which is referred to as “base feature vector,” and supplies the feature vector to an averaging unit 23. The averaging unit 23 calculates the average base feature vector by averaging the base feature vector output by the backbone CNN 22 for all support samples, and inputs the average base feature vector to MergeNet 36.

Output of an intermediate layer of the backbone CNN 22 is input to a MetaCNN 32. The MetaCNN 32 processes the output of the intermediate layer of the backbone CNN 22, outputs a feature vector of the novel class, which is referred to as “novel feature vector,” and supplies the feature vector to the averaging unit 33. The averaging unit 33 calculates the average novel feature vector by averaging the novel feature vector output by the MetaCNN 32 for all the support samples, and inputs the average novel feature vector to the MergeNet 36.

The MergeNet 36 processes the average base feature vector and the average novel feature vector with a neural network and outputs the task-specific mixture weight vectors ωₚᵣₑ and ωₘₑₜₐ for calculating a task-adaptive representation TAR.

The backbone CNN 22 operates as a base feature vector extractor f_{θ} for extracting a base feature vector for input x, and outputs a base feature vector f_{θ}(x) for the input x. The intermediate layer output of the backbone CNN 22 for the input x is denoted as a_{θ}(x). The MetaCNN 32 operates as a novel feature vector extractor g for extracting a novel feature vector for the intermediate layer output a_{θ}(x) and outputs a novel feature vector g (a_{θ}(x)) for the intermediate layer output a_{θ}(x).

FIG. 2B is a diagram explaining a configuration for calculating a task-adaptive representation TAR from the support set S so as to generate a classification weight vector set W based on the task-adaptive representation TAR.

A vector product arithmetic unit 25 calculates the product for each element between the base feature vector f_{θ} (x) output from the backbone CNN 22 and the mixture weight vector ωₚᵣₑ output from MergeNet 36 for each support sample x of the support set S, and outputs the product to a vector sum arithmetic unit 37.

A vector product arithmetic unit 35 calculates the product for each element between the novel feature vector g (a_{θ}(x)) output from the MetaCNN 32 and the mixture weight vector ωₘₑₜₐ output from a MergeNet 36 for the intermediate layer output a_{θ}(x) of the backbone CNN 22 for each support sample x of the support set S, and outputs the product to the vector sum arithmetic unit 37.

The vector sum arithmetic unit 37 calculates the vector sum of the product of the base feature vector f_{θ} (x) and the mixture weight vector ωₚᵣₑ and the product of the novel feature vector g (a_{θ}(x)) and the mixture weight vector ωₘₑₜₐ, outputs the vector sum as a task-adaptive representation TAR of each support sample x of the support set S, and provides the task-adaptive representation TAR to a TconNet 38 and a projection space construction unit 40. The task-adaptive representation TAR is a mixture feature vector consisting of a mixture of the base feature vector and the novel feature vector.

The calculation formula for the task-adaptive representation TAR is as follows, where the product of each component of a vector is expressed as x.

$$TAR = {ω}_{pre} \times {f}_{θ} ( x ) + {ω}_{meta} g ( {a}_{θ} ( x ) )$$

The calculation formula for the task adaptive representation TAR is to find the sum of element-by-element products between the mixture weight vector and the feature vector. The task adaptive representation TAR is calculated for each support sample in the support set S.

The TconNet 38 receives the input of a classification weight vector set W=[W_{base}, Wₙₒᵥₑₗ], and outputs a task-adjusted classification weight vector set W* using the task adaptive representation TAR of each support sample.

The projection space construction unit 40 constructs a task-adaptive projection space M such that the average {Ck} for each class k of the task-adaptive representation TAR of each support sample and W* obtained after task adjustment align in the projection space M.

FIG. 3 is a diagram explaining a configuration for calculating a task-adaptive representation TAR from a query set Q and classifying a query sample based on the task-adaptive representation TAR and a task-adjusted classification weight vector set W* so as to minimize classification loss.

The vector product arithmetic unit 25 calculates the product for each element between the base feature vector f_{θ} (x) output from the backbone CNN 22 and the mixture weight vector ωₚᵣₑ output from the MergeNet 36 for each query sample x of the query set Q, and outputs the product to the vector sum arithmetic unit 37.

The vector product arithmetic unit 35 calculates the product for each element between the novel feature vector g (a_{θ}(x)) output from the MetaCNN 32 and the mixture weight vector ωₘₑₜₐ output from the MergeNet 36 for the intermediate layer output a_{θ}(x) of the backbone CNN 22 for each query sample x of the query set Q, and outputs the product to the vector sum arithmetic unit 37.

The vector sum arithmetic unit 37 calculates the vector sum of the product of the base feature vector f_{θ} (x) and the mixture weight vector ωₚᵣₑ and the product of the novel feature vector g (a_{θ}(x)) and the mixture weight vector ωₘₑₜₐ, outputs the vector sum as a task-adaptive representation TAR of each query sample x of the query set Q, and provides the task-adaptive representation TAR to a projection space query classification unit 42.

The task-adjusted classification weight vector set W* output by the TconNet 38 is input to the projection space query classification unit 42.

The projection space query classification unit 42 calculates the Euclidean distance between the position of the task-adaptive representation TAR calculated for each query sample of the query set Q and the position of the average feature vector of a classification target class in the projection space M, and classifies the query sample into the closest class. It should be noted here that by the operation of the projection space construction unit 40, the average position of the classification target class in the projection space M aligns with the task-adjusted classification weight vector set W*.

A loss optimization unit 44 evaluates the classification loss in the query sample by a cross-entropy function, and proceeds with learning such that the classification result of the query set Q approaches the correct answer so as to minimize the classification loss. This allows learnable parameters of the MetaCNN 32, the MergeNet 36, and the TconNet 38 and a novel class classification weight Wₙₒᵥₑₗ to be updated such that the distance between the position of the task-adaptive representation TAR calculated for the query sample and the position of the average feature vector of the classification target class, i.e., the position of the task-adjusted classification weight vector set W*, becomes small.

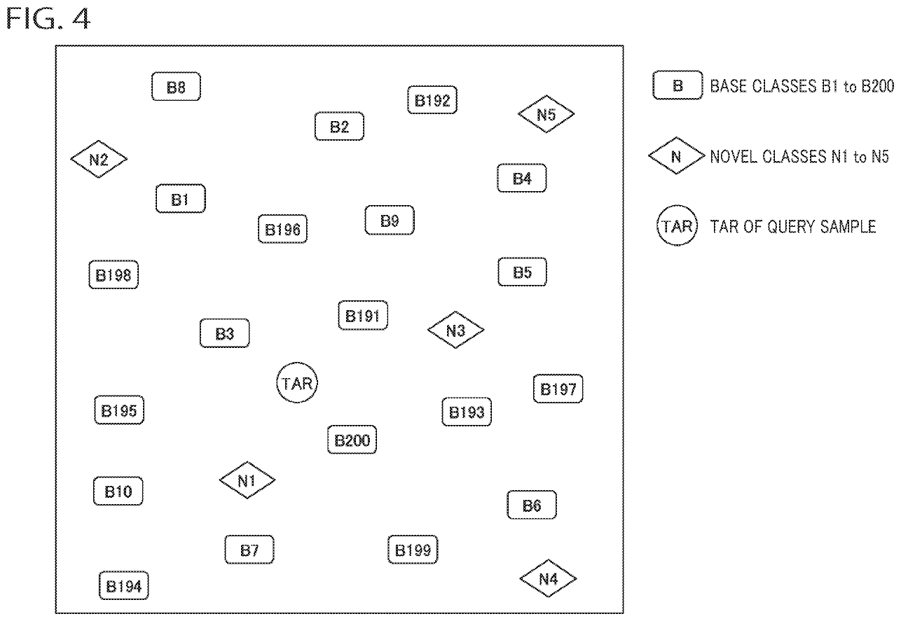

FIG. 4 is a conceptual diagram of a projection space M. The reference position of 200 base classes B1 to B200, which matches a task-adjusted base classification weight W_{base}*, the reference position of five novel classes N1 to N5, which matches a task-adjusted novel classification weight Wₙₒᵥₑₗ*, and the task-adaptive representation TAR of the query sample of the query set Q are projected onto the projection space M, and the projection space M functions as a joint classification space. For convenience, the base classes B11 to B190 are not shown in the figure.

The loss optimization unit 44 estimates the probability distribution of each class in the projection space M based on the Euclidean distance between the position of the task-adaptive representation TAR of the query sample and the average feature vector of each of the 205 classes, in which the base classes and the novel classes are combined, and calculates the classification loss using the cross-entropy function so as to minimize the loss.

Next, problems to be solved and means for solving the problems will be explained regarding the first embodiment of the present disclosure.

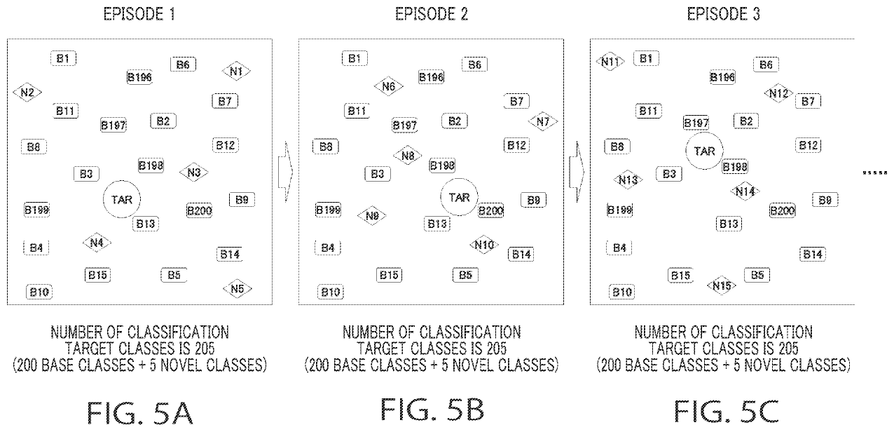

FIGS. 5A to 5C are diagrams explaining a conventional episodic learning procedure. As shown in FIG. 5A, 205 classes obtained by combining 200 base classes B1 to B200 and five novel classes N1 to N5 are classification target classes in Episode 1. As shown in FIG. 5B, 205 classes obtained by combining the 200 base classes B1 to B200 and five novel classes N6 to N10 are classification target classes in Episode 2. As shown in FIG. 5C, 205 classes obtained by combining the 200 base classes B1 to B200 and five novel classes N11 to N15 are classification target classes in Episode 3.

Thus, in conventional learning, the number of classification target classes is all 205 classes for each episode. Since the classification target classes constitute all the classes, it is difficult for the loss expressed by the cross-entropy function to converge, and it takes time to calculate the Euclidean distance for all the classes and estimate the probability distribution, which create a problem of increasing the overall learning time.

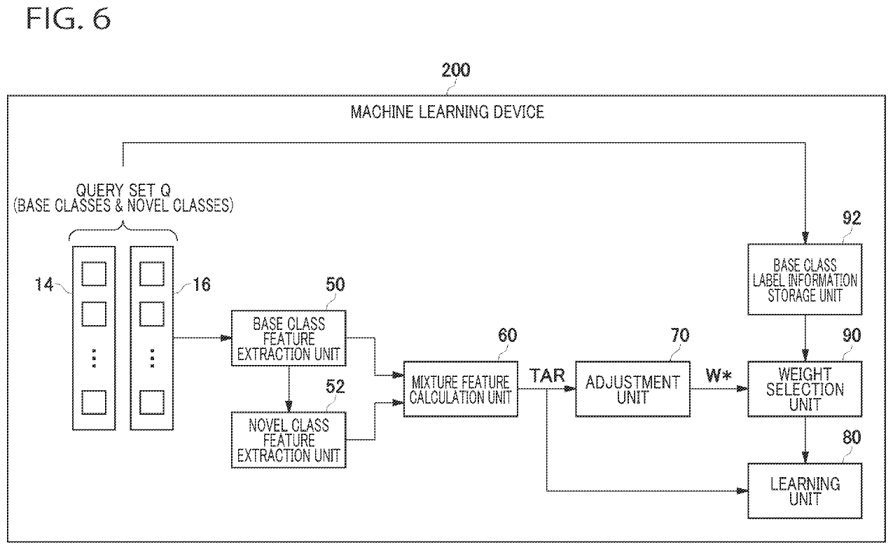

FIG. 6 is a configuration diagram of a machine learning device 200 according to the first embodiment of the present disclosure. In the figure, the explanation regarding configurations that are common to those in XtarNet will be omitted as appropriate, and an explanation will be given mainly regarding configurations to be added to those in XtarNet.

The machine learning device 200 includes a base class feature extraction unit 50, a novel class feature extraction unit 52, a mixture feature calculation unit 60, an adjustment unit 70, a learning unit 80, a weight selection unit 90, and a base class label information storage unit 92.

A query set Q consisting of a dataset 14 of a base class and a dataset 16 of a novel class is input to the base class feature extraction unit 50. An example of the base class feature extraction unit 50 is a backbone CNN 22. The base class feature extraction unit 50 extracts and outputs a base feature vector of each query sample of the query set Q.

The novel class feature extraction unit 52 receives intermediate output from the base class feature extraction unit 50 as input. An example of the novel class feature extraction unit 52 is a MetaCNN 32. The novel class feature extraction unit 52 extracts and outputs a novel feature vector of each query sample of the query set Q.

The mixture feature calculation unit 60 mixes the base and novel feature vectors of each query sample so as to calculate a mixture feature vector as a task-adaptive representation TAR, and provides the task-adaptive representation TAR to the adjustment unit 70 and the learning unit 80. An example of the mixture feature calculation unit 60 is MergeNet 36.

The adjustment unit 70 calculates a task-adjusted classification weight vector set W* using the task-adaptive representation TAR of each query sample, and provides the task-adjusted classification weight vector set W* to the weight selection unit 90. An example of the adjustment unit 70 is TconNet 38.

In meta-learning, labels are assigned to base classes of a query set Q. The base class label information storage unit 92 stores label information assigned to a base class selected for the query set Q in each episode, and provides the label information of the base class to the weight selection unit 90 for each episode.

In each episode, the weight selection unit 90 selects, from the task-adjusted classification weight vector set W* output from the adjustment unit 70, the weight of the classifier of the base class corresponding to the label information of the base class selected for the query set Q, and projects the selected weight of the classifier onto the projection space M.

The learning unit 80 classifies the query sample based on the distance between the position of the task-adaptive representation TAR of the query sample and the weight of the selected classifier in the projection space M, and learns to minimize the classification loss. Examples of the learning unit 80 are the projection space query classification unit 42 and the loss optimization unit 44.

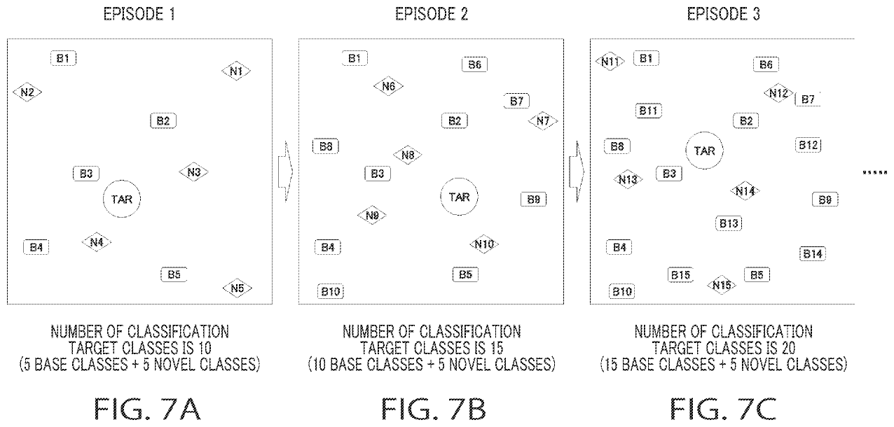

FIGS. 7A to 7C are diagrams explaining an episodic learning procedure according to the first embodiment. In meta-learning, labels are assigned to base classes of a query set Q. Using the label information of the base classes, a predetermined number of base classes selected as a query set Q are sequentially added and processed for each episode. As shown in FIG. 7A, five base classes B1 to B5 and five novel classes N1 to N5 selected for a query set in Episode 1 are projected onto the projection space M in Episode 1. Ten classes obtained by combining the five base classes B1 to B5 and the five novel classes N1 to N5 are classification target classes in Episode 1.

As shown in FIG. 7B, five base classes B6 to B10 and five novel classes N6 to N10 selected for a query set in Episode 2 are projected onto the projection space M in Episode 2 in addition to the five base classes B1 to B5 selected for the query set in Episode 1. Fifteen classes obtained by combining the 10 base classes B1 to B10 and the five novel classes N6 to N10 are classification target classes in Episode 2.

As shown in FIG. 7C, five base classes B11 to B15 and five novel classes N11 to N15 newly selected for a query set in Episode 3 are projected onto the projection space M in Episode 3 in addition to the 10 base classes B1 to B10 selected for the query sets in Episode 1 and Episode 2. Twenty classes obtained by combining the 15 base classes B1 to B15 and the five novel classes N11 to N15 are classification target classes in Episode 3.

FIGS. 7A to 7C show that the positions of classification target classes in the projection space M have not moved at all for ease of explanation; however, it should be noted that, in reality, the positions of the classification target classes change with each episode of learning. Five base classes selected for a query set are described to be added for each episode for ease of explanation; however, it should be noted that, in reality, five base classes are not always added since base classes that have never included in the query set before are added upon being introduced newly.

In this manner, instead of projecting all the base classes B1 to B200 onto the projection space M, a predetermined number of base classes to be selected in the query set, e.g., the same number as the number of novel classes selected in the query set, which is five in this case, are added sequentially. Thereby, the number of classification target classes can be reduced, the loss can converge more easily, and the learning time can be shortened, during a period until all the base classes are projected.

Next, problems to be solved and means for solving the problems will be explained regarding the second embodiment of the present disclosure.

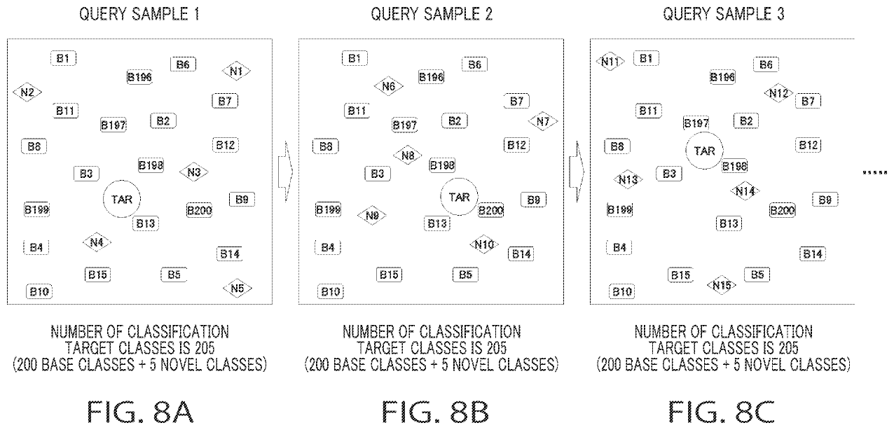

FIG. 8A to 8C are diagrams explaining a conventional loss calculation procedure for query samples. As shown in FIG. 8A, 205 classes obtained by combining 200 base classes B1 to B200 and five novel classes N1 to N5 are classification target classes in Query Sample 1. As shown in FIG. 8B, 205 classes obtained by combining the 200 base classes B1 to B200 and five novel classes N6 to N10 are classification target classes in Query Sample 2. As shown in FIG. 8C, 205 classes obtained by combining the 200 base classes B1 to B200 and five novel classes N11 to N15 are classification target classes in Query Sample 3.

Thus, in the conventional loss calculation, the number of classification target classes is all 205 classes for each query sample in a given episode. Since the query loss calculation targets all the classes, classes that are far away from the task-adaptive representation TAR of the query sample, i.e., classes with low relevance, are also taken into account in the calculation, which may lead to a decrease in classification accuracy. There is also a problem that the loss is difficult to converge and that learning takes time.

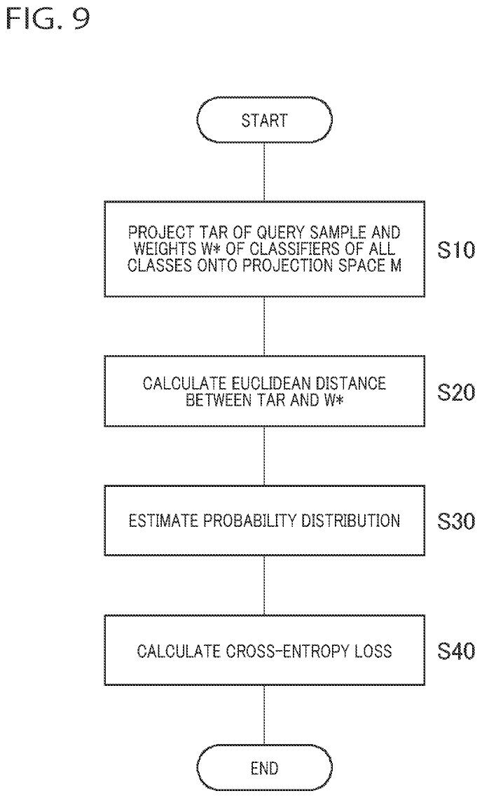

FIG. 9 shows a flowchart showing a conventional loss calculation procedure for a query sample. The task-adaptive representation TAR of the query sample and the weights W* of classifiers of all classes are projected onto a projection space M (S10). The Euclidean distance between the task-adaptive representation TAR of the query sample and the weights W* of the classifiers of all the classes is calculated (S20). The probability distribution of all the classes is estimated according to the Euclidean distance (S30). The cross-entropy loss for the classification of the query sample is calculated using the probability distribution of all the classes (S40).

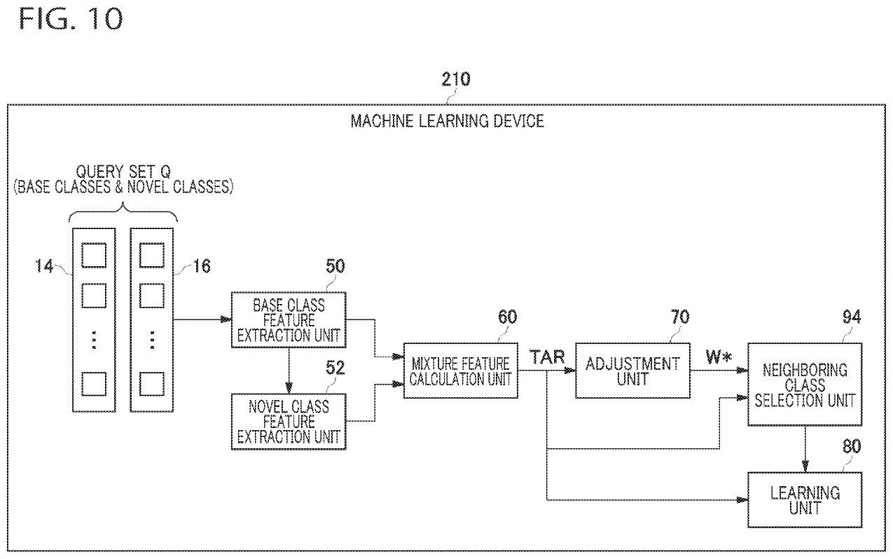

FIG. 10 is a configuration diagram of a machine learning device 210 according to the second embodiment of the present disclosure. In the figure, the explanation regarding configurations that are common to those in XtarNet will be omitted as appropriate, and an explanation will be given mainly regarding configurations to be added to those in XtarNet.

The machine learning device 210 includes a base class feature extraction unit 50, a novel class feature extraction unit 52, a mixture feature calculation unit 60, an adjustment unit 70, a learning unit 80, and a neighboring class selection unit 94.

A query set Q consisting of a dataset 14 of a base class and a dataset 16 of a novel class is input to the base class feature extraction unit 50. An example of the base class feature extraction unit 50 is a backbone CNN 22. The base class feature extraction unit 50 extracts and outputs a base feature vector of each query sample of a query set Q.

The novel class feature extraction unit 52 receives intermediate output from the base class feature extraction unit 50 as input. An example of the novel class feature extraction unit 52 is MetaCNN 32. The novel class feature extraction unit 52 extracts and outputs a novel feature vector of each query sample of the query set Q.

The mixture feature calculation unit 60 mixes the base and novel feature vectors of each query sample so as to calculate a mixture feature vector as a task-adaptive representation TAR, and provides the task-adaptive representation TAR to the adjustment unit 70, the neighboring class selection unit 94, and the learning unit 80. An example of the mixture feature calculation unit 60 is MergeNet 36.

The adjustment unit 70 calculates a task-adjusted classification weight vector set W* using the task-adapted representation TAR of each query sample, and provides the task-adjusted classification weight vector set W* to the neighboring class selection unit 94. An example of the adjustment unit 70 is TconNet 38.

The neighboring class selection unit 94 selects a predetermined number of classes that are within a predetermined distance from the position of the task-adapted representation TAR of the query sample as neighboring classes based on the Euclidean distance between the task-adapted representation TAR of the query sample and the task-adjusted classification weight vector set W* for all the classes in the projection space M, and provides the weights of classifiers of the selected predetermined number of neighboring classes to the learning unit 80.

When the classes located within the predetermined distance from the position of the task-adaptive representation TAR of the query sample do not include classes with correct labels in the projection space M, the neighboring class selection unit 94 expands a target range until correct classes are included and selects neighboring classes.

The learning unit 80 classifies the query sample according to the distance between the position of the task-adaptive representation TAR of the query sample and the weight of the selected classifier in the projection space M, and learns to minimize the classification loss. Examples of the learning unit 80 are the projection space query classification unit 42 and the loss optimization unit 44.

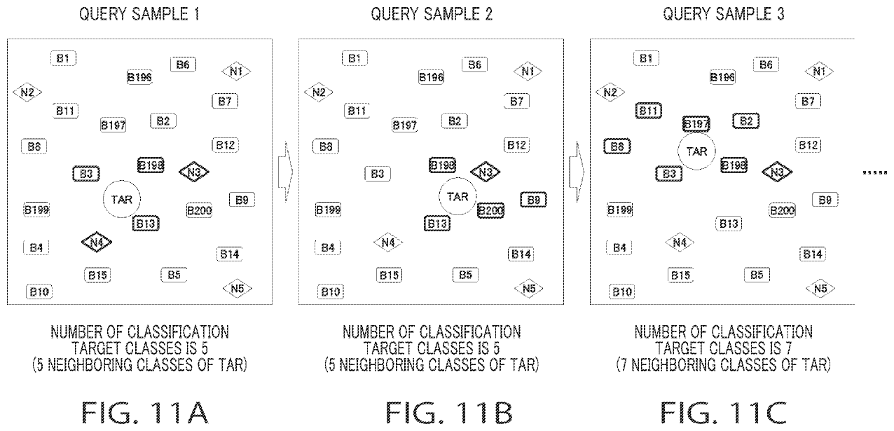

FIG. 11A to 11C are diagrams explaining a loss calculation procedure for query samples according to the second embodiment.

As shown in FIG. 11A, for Query Sample 1, the five neighboring classes B198, B3, N3, B13, and N4, which are close to the TAR of Query Sample 1, are selected as target classes for loss calculation.

As shown in FIG. 11B, for Query Sample 2, the five neighboring classes B198, N3, B9, B200, and B13, which are close to the TAR of Query Sample 2, are selected as target classes for loss calculation.

As shown in FIG. 11C, in Query Sample 3, since five neighboring classes, which are close to the TAR of Query Sample 3, do not include correct classes for Query Sample 3, a target range is expanded until the correct classes are included. In this example, since a correct class appears for the first time in the seventh closest class from the TAR, seven neighboring classes B11, B2, B197, B8, B198, B3, and N3 are treated as target classes for loss calculation.

In this way, classes that are close to the task-adaptive representation TAR of the query sample, i.e., classes with low high, are selected, and the classification loss is calculated for the selected classes. This improves the classification accuracy of the query set and also reduces the number of target classes for loss calculation, thereby facilitating loss convergence.

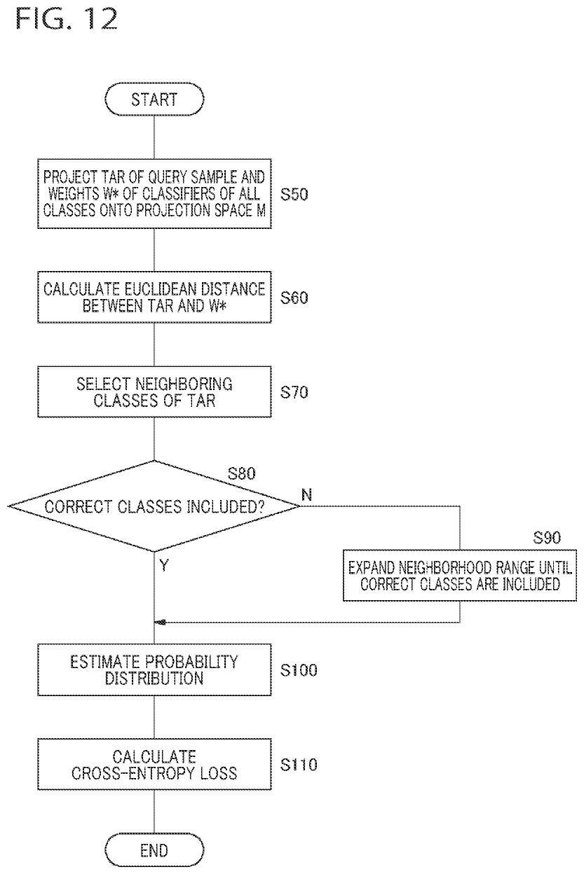

FIG. 12 shows a flowchart showing a loss calculation procedure for a query sample according to the second embodiment. The task-adaptive representation TAR of the query sample and the weights W* of classifiers of all classes are projected onto a projection space M (S50). The Euclidean distance between the task-adaptive representation TAR of the query sample and the weights W* of the classifiers of all the classes is calculated (S60).

A predetermined number of classes near the task-adaptive representation TAR of the query sample are selected (S70). If correct classes are included in the selected classes (Y in S80), the step proceeds to step S100. If correct classes are not included in the selected classes (N in S80), a neighborhood range is extended until correct classes are included so as to select neighboring classes (S90), and the step then proceeds to step S100.

The probability distribution of the selected classes is estimated according to the Euclidean distance (S100). The cross-entropy loss for the classification of the query sample is calculated using the probability distribution of the selected classes (S110).

The above-described various processes in the machine learning devices 200 and 210 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the programs may be transmitted to and/or received from a server via a wired or wireless network. Still alternatively, the programs may be transmitted and/or received in the form of data transmission over terrestrial or satellite digital broadcast systems.

As described above, in a conventional incremental few-shot learning method such as XtarNet, all pre-learned base classes are projected onto a projection space, a joint classification space, at the time of calculating query loss in meta-learning, and query loss is calculated over all the base classes, making loss convergence to be difficult and taking too much time for learning. In contrast, according to the machine learning device 200 of the first embodiment, optimization of classification target classes related to loss calculation during meta-learning can facilitate loss convergence and reduce learning time.

More specifically, labels are assigned to base classes of a query set in meta-learning. By using this base class label information and sequentially adding base classes selected for a query set of each episode in a projection space when calculating query loss, the number of classification target classes can be reduced during a period until all the pre-learned base classes are projected onto the projection space. This facilitates loss convergence and reduces learning time.

Further, in a conventional incremental few-shot learning method such as XtarNet, all pre-learned base classes and novel classes are projected onto a projection space, which is a joint classification space, in meta-learning, and query loss is calculated over all the classes; therefore, classes that are less related to the task-adaptive representation of the query sample are also taken into account in the calculation, which may lead to a decrease in the classification accuracy. Further, the loss is difficult to converge, and learning takes time. In contrast, according to the machine learning device 210 of the second embodiment, limitation of classification target classes in loss calculation during meta-learning to classes that are highly related to the task-adaptive representation can facilitate loss convergence and improve the classification accuracy.

Described above is an explanation of the present disclosure based on the embodiments. The embodiments are intended to be illustrative only, and it will be obvious to those skilled in the art that various modifications to constituting elements and processes could be developed and that such modifications are also within the scope of the present disclosure.

What is claimed is:

1. A machine learning device that performs continual learning of a fewer number of novel classes than the number of base classes, comprising:
a base class feature extraction unit that extracts feature vectors of the base classes;
a novel class feature extraction unit that extracts feature vectors of the novel classes;
a mixture feature calculation unit that mixes the feature vectors of the base classes and the feature vectors of the novel classes and calculates a mixture feature vector of the base classes and the novel classes;
a learning unit that classifies a query sample of a query set based on the distance between the position of a mixture feature vector of the query sample of the query set and the position of a classification weight vector of each class in a projection space and learns classification weight vectors of the novel classes so as to minimize classification loss; and
a weight selection unit that sequentially adds classification weight vectors of base classes selected for the query set in the projection space at the time of learning the query set in units of episodes.

2. The machine learning device according to claim 1, further comprising:
a neighbor selection unit that selects a predetermined number of classes located within a predetermined distance from the position of the mixture feature vector of the query sample as neighboring classes in the projection space,
wherein the neighbor selection unit expands a target range until classes with correct labels are included and selects neighboring classes when the classes located within the predetermined distance from the position of the mixture feature vector of the query sample do not include classes with correct labels in the projection space, and
wherein the learning unit classifies the query sample of the query set based on the distance between the position of the mixture feature vector of the query sample and the position of classification weight vectors of the selected predetermined number of neighboring classes in the projection space and learns classification weight vectors of the novel classes so as to minimize classification loss.

3. A machine learning method that performs continual learning of a fewer number of novel classes than the number of base classes, comprising:
extracting feature vectors of the base classes;
extracting feature vectors of the novel classes;
mixing the feature vectors of the base classes and the feature vectors of the novel classes and calculating a mixture feature vector of the base classes and the novel classes;
classifying a query sample of a query set based on the distance between the position of a mixture feature vector of the query sample of the query set and the position of a classification weight vector of each class in a projection space and learning classification weight vectors of the novel classes so as to minimize classification loss; and
sequentially adding classification weight vectors of base classes selected for the query set in the projection space at the time of learning the query set in units of episodes.

4. A non-transitory computer-readable recording medium embodied thereon a machine learning program that performs continual learning of a fewer number of novel classes than the number of base classes, the program comprising computer-implemented modules including:
a base class feature extraction module that extracts feature vectors of the base classes;
a novel class feature extraction module that extracts feature vectors of the novel classes;
a mixture feature calculation module that mixes the feature vectors of the base classes and the feature vectors of the novel classes and calculates a mixture feature vector of the base classes and the novel classes;
a learning module that classifies a query sample based on the distance between the position of a mixture feature vector of the query sample of a query set and the position of a classification weight vector of each class in a projection space and learns classification weight vectors of the novel classes so as to minimize classification loss; and
a weight selection module that sequentially adds classification weight vectors of base classes selected for the query set in the projection space at the time of learning the query set in units of episodes.
